(19) United States
(12) Patent Application Publication
(10) Pub. No.: US 2008/0230033 A1
(43) Pub. Date: Sep. 25, 2008

(54) Throttle lever breakaway mechanism

(76) Inventors: Mark D. Reed, Springfield, IL (US); Al B. Cable, Springfield, IL (US)

Correspondence Address: Bryan Anderson;Patent Services, Honeywell International Inc., 101 Columbia Road, Morristown, NJ, 07962, US

(21) Appl. No.: 11/726,280

(22) Filed: Mar. 21, 2007

(51) Int. Cl. F02B 77/08

(52) U.S. Cl. 123/198 D

(57) ABSTRACT

A throttle lever for use with vehicles such as ATVs with a throttle housing including a vehicle throttle control mechanism. The lever engages the control mechanism by a shaft engaging the control mechanism. A throttle lever arm rotates the shaft to control the throttle control. A failure point on the lever is placed external of the housing, whereby impact on the throttle lever arm causes failure at the failure point, leaving a portion of the throttle lever arm for continued. The preferred failure is a groove on the lever arm facing toward the direction of travel of the vehicle.

### FIELD OF THE INVENTION

The present invention relates to an improved throttle lever mechanism for All Terrain Vehicles (ATV). More particularly, the invention relates to a breakaway mechanism on the throttle lever of ATVs and the like which permits the ATV to be operated after an impact that breaks the throttle lever.

### BACKGROUND OF THE INVENTION

ATVs have become very popular consumer products in recent years. These vehicles are typically used by one rider to travel undeveloped terrain, often called “off-road” connoting the lack of paved or even defined paths. ATVs are used for both off-road work and recreation. Due to the off-road use, ATVs commonly encounter obstacles such as rocks, steep hills, and ditches and may travel over loose, granular fill, unstable mud or shallow water.

To accommodate the different, and often rugged, terrain, such vehicles are generally designed with a powerful drive system to enhance mobility and traction and provide sufficient force to push or pull various objects. Additionally, as these vehicles may be required to travel over or under obstacles, ATVs are typically designed to be as compact and light-weight as possible to allow a rider to maneuver the vehicle in difficult circumstances. In some cases, a rider must manually move or free the vehicle by pushing, pulling or tipping the vehicle.

As a result of traversing such rugged terrain, the rider is often subjected to an uneven or unbalanced ride. It may be necessary, depending on the inclination of the vehicle or slope of the terrain, for the rider to balance the vehicle by shifting his or her body weight or leaning against the tilt of the vehicle. Often, riders must clamp onto the seat or body of the ATV with their legs to maintain control and remain astride the vehicle.

As a result of robust use of ATVs on difficult terrain, accidents happen. Catastrophic failure of an ATV throttle lever due to impact of objects such as tree branches during normal riding conditions or with the ground in the event of a vehicle rollover causes the vehicle to become inoperable. The failure of the throttle lever often occurs internal to the throttle control housing, thus causing the throttle lever arm to become separated from the throttle housing, leaving no means to operate the throttle cable mechanism on the ATV.

Efforts to make the throttle lever stronger are limited by the size of the throttle housing and the space available on an ATV to accommodate larger components.

It would be of advantage in the art if a device could be provided that would allow an ATV or other vehicle having a throttle lever to operate even after failure of the lever due to impact.

Yet another advantage would be if the throttle lever of ATVs and the like could protect the internal components in the housing.

Other advantages will appear hereinafter.

### SUMMARY OF THE INVENTION

It has now been discovered that the above and other advantages of the present invention may be obtained in the following manner. Specifically, the present invention defines a location on the throttle lever for the catastrophic failure to occur. This is accomplished b providing a point along the length of the lever arm that is structurally weaker than the rest of the throttle lever.

This weak point is preferably made by forming a relief notch in the surface of the lever arm. By placing this failure point external to the throttle control housing and away from the throttle lever pivot axis, the effects of such a failure are minimized to the loss of only part of the throttle lever. This leaves the functionality of the throttle control intact to allow operation of the vehicle, at least back to a repair shop.

In a preferred embodiment, the failure point is placed on the outside (or side facing the normal direction of travel) because most throttle lever failures are caused by impact with trees, branches, and other hard objects that are encountered as the vehicle moves in the primary direction. The operator pushes on the throttle lever to increase speed and in this embodiment the lever is stronger in the direction of use by the operator than it is when impacted while traveling in that direction.

While this invention is described with reference to ATVs, it is understood that other vehicles having throttle levers that extend from a housing and are operated by hand, such as snowmobiles, “four-wheelers” garden tractors, lawn mowers, snow blowers and the like are also within the scope of this invention.

### BRIEF DESCRIPTION OF THE DRAWINGS

For a more complete understanding of the invention, reference is hereby made to the drawings, wherein like numbers refer to like elements, and in which:

FIG. 1 is a perspective view of a vehicle throttle lever; and

FIG. 2 is a perspective view of the lever of FIG. 1 shown mounted in a housing of a typical vehicle.

### DETAILED DESCRIPTION OF THE PREFERRED EMBODIMENT

The present invention provides for substantial improvements in operational safety of vehicles such as ATVs and the like. The single most common disabling damage to such devices that have throttle levers occurs when the operator comes too close to a tree or tree branch or other solid object while traveling at speed, and the throttle lever breaks. In conventional machines, the break almost always occurs inside the housing, and thus the operator cannot continue to drive the vehicle. If this accident happens in a remote area where the operator is alone, the accident could be life threatening.

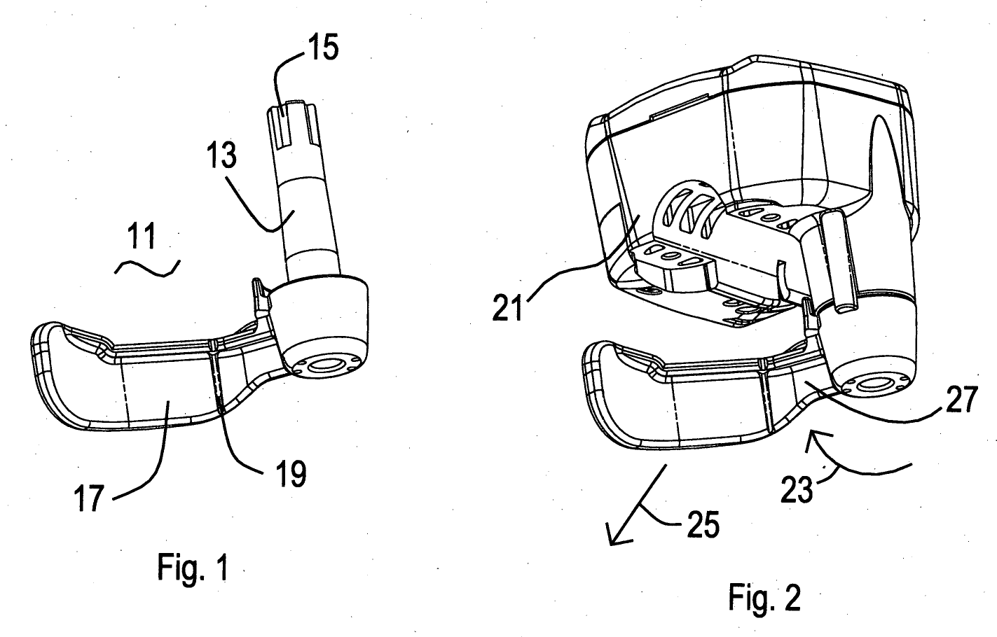

In FIG. 1, a throttle lever 11, generally, includes a shaft portion 13 that has a throttle cable mechanism engaging end 15. This is a conventional design on ATVs and other vehicles of the same driving mechanism. The lever 17 is on the other end of shaft 13 and includes a failure point 19, shown as a groove in the drawings. The shaft 13 is shown inserted into the housing 21 in FIG. 2.

The preferred location of groove 19 is on the side of the lever toward the direction of travel, shown by arrow 23, because most often the impact that damages the lever 17 comes in the direction shown by arrow 25. Even after impact, the lever 17 retains a portion 27 that allows the vehicle to operate and thus the operator can find help or return home or to other places of interest.

While particular embodiments of the present invention have been illustrated and described, it is not intended to limit the invention, except as defined by the following claims.

1. A throttle device for use with vehicles having a throttle lever, comprising:
a throttle housing including a vehicle throttle control mechanism, said housing having an opening for insertion of a throttle lever into said housing for engagement with said throttle control mechanism;
a throttle lever having a throttle control engaging shaft having a first end operable to be inserted into said opening and engage said throttle control mechanism and a second end extending out of said housing along the axis of said shaft;
throttle lever arm for engagement with said second end of said shaft, whereby pressure on said throttle lever arm rotates said shaft about its axis to control the throttle control mechanism; and
a failure point on said throttle lever arm, said failure point being external of said housing, whereby impact on said throttle lever arm causes failure at said failure point, leaving a portion of said throttle lever arm for continued use after failure.

2. The device of claim 1, wherein said throttle control mechanism is a throttle cable mechanism operable upon rotation of said throttle lever control engaging shaft about the axis of said shaft.

3. The device of claim 2, wherein said vehicle is an ATV.

4. The device of claim 1, wherein said failure point on said lever arm is a groove on said lever arm facing toward the normal direction of travel of said vehicle.

5. The device of claim 4, wherein said failure point on said lever arm is a groove generally parallel to the axis of said shaft.

6. The device of claim 5, wherein said groove on said lever arm is facing toward the normal direction of travel of said vehicle.

7. A throttle device for use with vehicles having a throttle lever, comprising:
throttle housing means for providing a vehicle throttle control mechanism, said housing means having an opening for insertion of a throttle lever into said housing for engagement with said throttle control mechanism;
throttle lever means for engaging said throttle control mechanism and having a throttle control engaging shaft having a first end operable to be inserted into said opening and engage said throttle control mechanism and a second end extending out of said housing along the axis of said shaft;
throttle lever arm means for engagement with said second end of said shaft, whereby pressure on said throttle lever arm rotates said shaft about its axis to control the throttle control mechanism; and
failure means on said throttle lever arm for causing failure at a predetermined failure point, said failure point being external of said housing, whereby impact on said throttle lever arm leaves a portion of said throttle lever arm means for continued use after failure.

8. The device of claim 7, wherein said throttle control mechanism is a throttle cable mechanism operable upon rotation of said throttle lever means engaging said shaft about the axis of said shaft.

9. The device of claim 8, wherein said vehicle is an ATV.

10. The device of claim 7, wherein said failure point on said lever arm means is a groove on said lever arm means facing toward the normal direction of travel of said vehicle.

11. The device of claim 10, wherein said failure point on said lever arm means is a groove generally parallel to the axis of said shaft.

12. The device of claim 11, wherein said groove on said lever arm means is facing toward the normal direction of travel of said vehicle.

13. A throttle lever device for use with vehicles having a throttle housing including a vehicle throttle control mechanism, said housing having an opening for insertion of a throttle lever into said housing for engagement with said throttle control mechanism, said device comprising:
a throttle lever having a throttle control engaging shaft having a first end operable to be inserted into said opening an d engage said throttle control mechanism and a second end extending out of said housing along the axis of said shaft;
throttle lever arm for engagement with said second end of said shaft, whereby pressure on said throttle lever arm rotates said shaft about its axis to control the throttle control mechanism; and
a failure point on said throttle lever arm, said failure point being external of said housing, whereby impact on said throttle lever arm causes failure at said failure point, leaving a portion of said throttle lever arm for continued use after failure.

14. The device of claim 13, wherein said throttle control mechanism is a throttle cable mechanism operable upon rotation of said throttle lever control engaging shaft about the axis of said shaft.

15. The device of claim 14, wherein said vehicle is an ATV.

16. The device of claim 13, wherein said failure point on said lever arm is a groove on said lever arm facing toward the normal direction of travel of said vehicle.

17. The device of claim 16, wherein said failure point on said lever arm is a groove generally parallel to the axis of said shaft.

18. The device of claim 17, wherein said groove on said lever arm is facing toward the normal direction of travel of said vehicle.
